(19) United States
(12) Patent Application Publication
(10) Pub. No.: US 2024/0302177 A1
(43) Pub. Date: Sep. 12, 2024

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Naotoshi KADOTANI, Mishima-shi (JP); Yuki NISHIKAWA, Numazu-shi (JP); Yuki TAKAHASHI, Sunto-gun (JP); Nana KIKUIRE, Sunto-gun (JP); Takahiko KUWABARA, Yokohama-shi (JP); Ryusei GICHU, Tokyo (JP); Takashi OTA, Tokyo (JP); Toshifumi IWASE, Tokyo (JP); Hironori ITO, Tokyo (JP); Hisanobu INOUE, Kawasaki-shi (JP)

(73) Assignee: TOYOTA JIDOSHA KABUSHIKI KAISHA, Toyota-shi (JP)

(21) Appl. No.: 18/589,827

(22) Filed: Feb. 28, 2024

(30) Foreign Application Priority Data
Mar. 6, 2023 (JP) 2023-033977

(51) Int. Cl. G01C 21/34; B60W 60/00; G01C 21/36

(52) U.S. Cl. CPC G01C 21/3461; G01C 21/3415; G01C 21/3691; B60W 60/00253; B60W 2554/406

(57) ABSTRACT

An information processing device includes one or more processors configured to: set, as a travel destination of a vehicle, a point where an occupant of the vehicle gets out of the vehicle to transfer from the vehicle to a regularly operated transportation facility; acquire delay information indicating occurrence of a delay of the regularly operated transportation facility or occurrence of an event that causes a delay in travel of the vehicle to the travel destination; and change the travel destination of the vehicle based on the delay information.

### CROSS-REFERENCE TO RELATED APPLICATION

This application claims priority to Japanese Patent Application No. 2023-033977 filed on Mar. 6, 2023, incorporated herein by reference in its entirety.

### BACKGROUND

### 1. Technical Field

The present disclosure relates to an information processing device, an information processing method, and a non-transitory storage medium.

### 2. Description of Related Art

In the field of multimodal route search of searching for a route combining a plurality of means of transportation, there is a related art that proposes a route of using optimal means of transportation according to the weather on the route (e.g., see Japanese Unexamined Patent Application Publication No. 2022-130046).

### SUMMARY

In such a search for a multimodal route involving transfer from a vehicle to a regularly operated transportation facility, for example, when a delay occurs in travel of the vehicle due to traffic congestion, or a delay occurs in the regularly operated transportation facility, after a point where an occupant of the vehicle gets out of the vehicle to transfer from the vehicle to the regularly operated transportation facility is set as a travel destination of the vehicle, the occupant of the vehicle is often delayed in arriving at a final destination due to the influence of such a delay. In this case, if the travel destination of the vehicle is changed to a travel destination that is as little affected by the influence of such a delay as possible, efficient travel can be provided to the occupant of the vehicle. However, the multimodal route search technology in the above-described related art does not suggest such a possibility.

An information processing device according to a first aspect of the present disclosure includes one or more processors configured to: set, as a travel destination of a vehicle, a point where an occupant of the vehicle gets out of the vehicle to transfer from the vehicle to a regularly operated transportation facility; acquire delay information indicating occurrence of a delay of the regularly operated transportation facility or occurrence of an event that causes a delay in travel of the vehicle to the travel destination; and change the travel destination based on the delay information.

Further, an information processing method according to a second aspect of the present disclosure that performs information processing using one or more processors includes: setting, as a travel destination of a vehicle, a point where an occupant of the vehicle gets out of the vehicle to transfer from the vehicle to a regularly operated transportation facility; acquiring delay information indicating occurrence of a delay of the regularly operated transportation facility or occurrence of an event that causes a delay in travel of the vehicle to the travel destination; and changing the travel destination based on the delay information.

Moreover, a non-transitory storage medium according to a third aspect of the present disclosure storing instructions that are executable by one or more processors and that cause the one or more processors to perform functions, the functions comprising: setting, as a travel destination of a vehicle, a point where an occupant of the vehicle gets out of the vehicle to transfer from the vehicle to a regularly operated transportation facility; acquiring delay information indicating occurrence of a delay of the regularly operated transportation facility or occurrence of an event that causes a delay in travel of the vehicle to the travel destination; and changing the travel destination based on the delay information.

Efficient travel can be provided to an occupant of a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an overall view of an information processing system;

FIG. 2 is a view graphically showing the information processing server shown in FIG. 1;

FIG. 3 is a view graphically showing the vehicle dispatch management server shown in FIG. 1;

FIG. 4 is a view graphically showing a self-driving taxi;

FIG. 5 is a functional configuration diagram of the self-driving taxi shown in FIG. 4;

FIG. 6 is a view showing a flow of information processing in the information processing system;

FIG. 7 is a view showing the procedure of input on a terminal;

FIG. 8 is a view showing the procedure of selecting a route on the terminal;

FIG. 9 is a flowchart for performing information processing 1;

FIG. 10 is a flowchart for performing vehicle dispatch management;

FIG. 11 is a view showing a graphically represented road map;

FIG. 12 is a view showing a graphically represented road map;

FIG. 13 is a view showing a graphically represented road map;

FIG. 14 is a view showing a graphically represented road map;

FIG. 15 is a view showing a graphically represented road map;

FIG. 16 is a view showing a graphically represented road map;

FIG. 17 is a view showing a graphically represented road map;

FIG. 18 is a view showing a graphically represented road map;

FIG. 19 is a flowchart for performing information processing 2;

FIG. 20 is a flowchart for performing the information processing 2;

FIG. 21 is a flowchart for performing a process of regenerating a travel route that mitigates the influence of a delay;

FIG. 22 is a flowchart for performing a process of regenerating a travel route that mitigates the influence of congestion;

FIG. 23 is a flowchart for performing a process of regenerating a travel route that mitigates the influence of a delay and congestion;

FIG. 24 is a flowchart for performing a process of regenerating a travel route that mitigates the influence of a delay and congestion;

FIG. 25 is a flowchart for performing driving control of the self-driving taxi;

FIG. 26 is a flowchart for performing driving control of the self-driving taxi; and

FIG. 27 is a flowchart for performing driving control of the self-driving taxi.

### DETAILED DESCRIPTION OF EMBODIMENTS

When a person travels to a destination, usually, there is a plurality of travel routes as travel routes for traveling to the destination, and one travel route is selected from among the plurality of travel routes. In this case, a travel route that uses a plurality of different types of mobile bodies, for example, a travel route that involves transfer from a vehicle to a regularly operated transportation facility is sometimes selected as the travel route. In this case, a point where an occupant of the vehicle gets out of the vehicle to transfer from the vehicle to the regularly operated transportation facility is set as a travel destination of the vehicle, and the occupant of the vehicle travels to this travel destination of the vehicle by using the vehicle, and thereafter travels by using the regularly operated transportation facility. The present disclosure relates to an information processing technology that, when, in such cases, there is a delay in the regularly operated transportation facility or when there is a delay in travel of the vehicle due to traffic congestion, changes the travel route and changes the travel destination of the vehicle such that such a delay does not affect the travel of the occupant of the vehicle or such that the influence of such a delay is minimized. In this case, a manually driven vehicle, a self-driving vehicle, a private vehicle, a commercial vehicle such as a taxi correspond to a vehicle to which the present disclosure is applied, and a railroad such as a train, a monorail, a bus, and an airplane correspond to a regularly operated transportation facility to which the present disclosure is applied. In the following, the present disclosure will be described based on the example of a case where the vehicle is a self-driving taxi and the regularly operated transportation facility is a railroad such as a train. However, it goes without saying that the present disclosure is applicable to a manually driven vehicle, a self-driving vehicle, a private vehicle, a commercial vehicle such as a taxi, etc. other than a self-driving taxi, and applicable to a monorail vehicle, a bus, and an airplane other than a railroad. When the present disclosure is applied to a railroad such as a train, the term “place of arrival and departure” used in the following description refers to a “railroad station.” When the present disclosure is applied to a bus, the term “place of arrival and departure” refers to a “bus stop,” and when the present disclosure is applied to an airplane, the term “place of arrival and departure” refers to an “airport of an airplane.” Thus, the term “place of arrival and departure” in the present disclosure covers a “railroad station,” a “bus stop,” and an “airport of an airplane.”

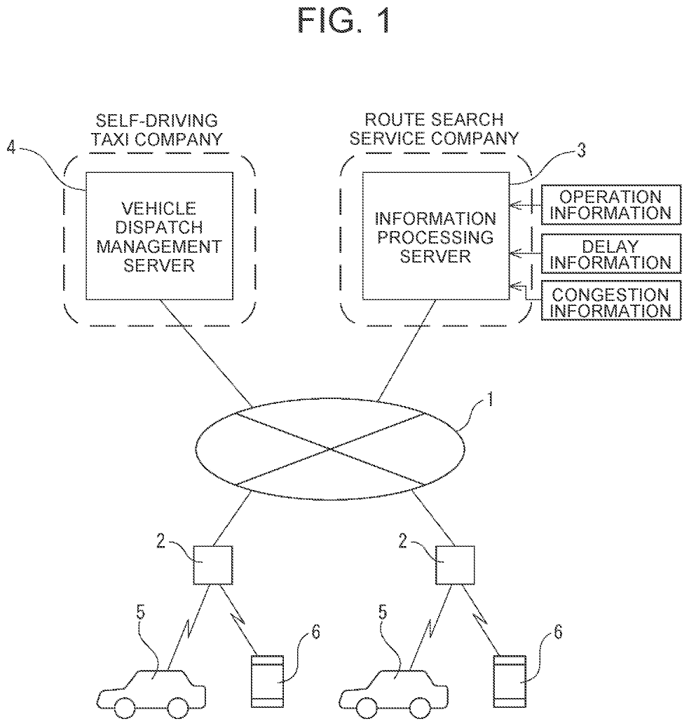

FIG. 1 shows an overall view of an information processing system suitable for implementing the information processing technology according to the present disclosure. Referring to FIG. 1, reference sign 1 denotes a communication network; 2 denotes a base station of the communication network 1; 3 denotes an information processing server that is managed by a route search service company; 4 denotes a vehicle dispatch management server that is managed by a self-driving taxi company and provides a service of dispatching self-driving taxis; 5 denotes a self-driving taxi; and 6 denotes a terminal owned by a user who uses the service of dispatching self-driving taxis 5. While the terminal 6 is depicted as a mobile terminal in FIG. 1, this terminal 6 is not limited to a mobile terminal and may instead be a stationary terminal.

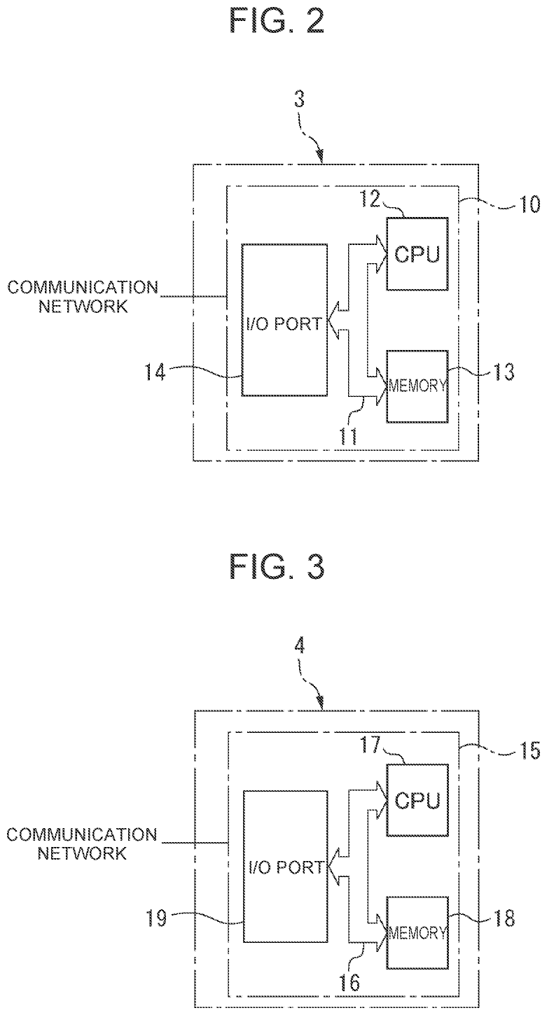

FIG. 2 shows the information processing server 3 shown in FIG. 1. Referring to FIG. 2, an electronic control unit 10 is provided inside the information processing server 3. This electronic control unit 10 is formed by a digital computer, and includes a CPU (microprocessor) 12, a memory 13 composed of a ROM and a RAM, and an input-output port 14 that are connected to one another by a bidirectional bus 11. The electronic control unit 10 is connected to the communication network 1.

FIG. 3 shows the vehicle dispatch management server 4 shown in FIG. 1. Referring to FIG. 3, an electronic control unit 15 is provided inside the vehicle dispatch management server 4. This electronic control unit 15 is formed by a digital computer, and includes a CPU (microprocessor) 17, a memory 18 composed of a ROM and a RAM, and an input-output port 19 that are connected to one another by a bidirectional bus 16. The electronic control unit 15 is connected to the communication network 1.

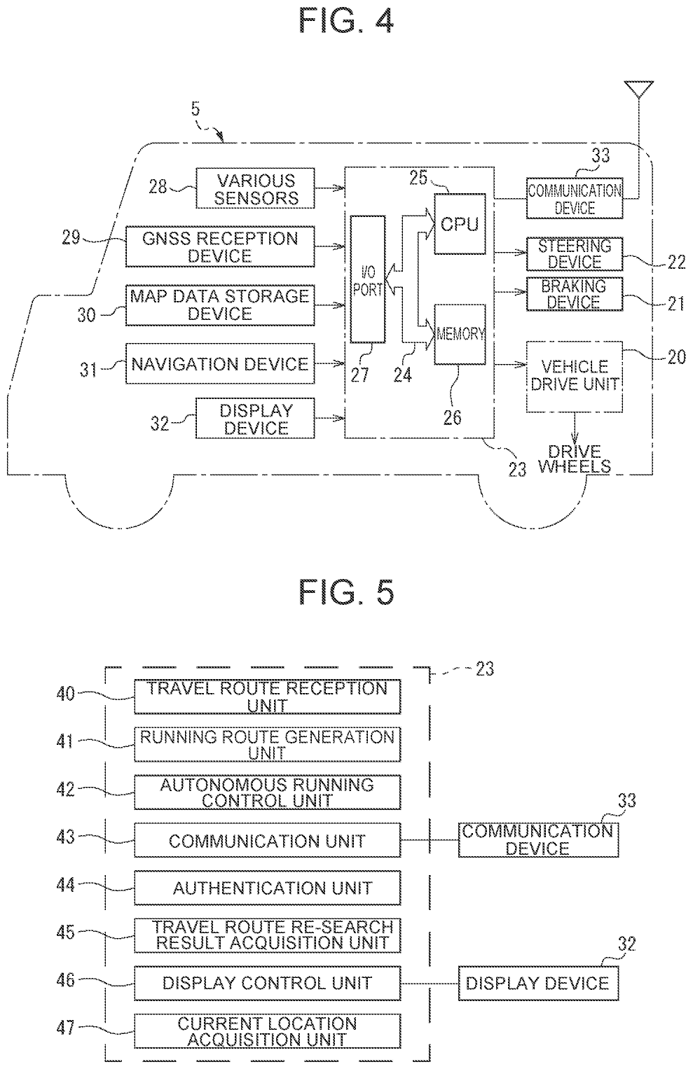

FIG. 4 graphically shows one example of the self-driving taxi 5. Referring to FIG. 4, reference sign 20 denotes a vehicle drive unit that gives a driving force to drive wheels of the self-driving taxi 5; 21 denotes a braking device that brakes the self-driving taxi 5; 22 denotes a steering device that steers the self-driving taxi 5, and 23 denotes an electronic control unit installed in the self-driving taxi 5. As shown in FIG. 4, the electronic control unit 23 is formed by a digital computer, and includes a CPU (microprocessor) 25, a memory 26 composed of a ROM and a RAM, and an input-output port 27 that are connected to one another by a bidirectional bus 24. In the example shown in FIG. 4, the vehicle drive unit 20 is formed by an electric motor that is driven by a secondary battery or an electric motor that is driven by a fuel cell, and driving of the drive wheels is controlled by this electric motor in accordance with an output signal of the electronic control unit 23. Braking control of the self-driving taxi 5 is performed by the braking device 21 in accordance with an output signal of the electronic control unit 23, and steering control of the self-driving taxi 5 is performed by the steering device 22 in accordance with an output signal of the electronic control unit 23. The electronic control unit 23 can be composed of one electronic control unit as well as can be composed of a plurality of electronic control units.

On the other hand, as shown in FIG. 4, various sensors 28 required for the self-driving taxi 5 to drive autonomously, i.e., sensors that detect states of the self-driving taxi 5 and surroundings detection sensors that detect the surroundings of the self-driving taxi 5 are installed in the self-driving taxi 5. In this case, as the sensors that detect states of the self-driving taxi 5, an acceleration sensor, a speed sensor, and an azimuth angle sensor are used, and as the surrounding detection sensors that detect the surroundings of the self-driving taxi 5, on-board cameras that photograph a front side, lateral sides, and a rear side of the self-driving taxi 5, a lidar, a radar, etc. are used. Further, the self-driving taxi 5 is provided with a global navigation satellite system (GNSS) reception device 29, a map data storage device 30, a navigation device 31, and a display device 32 including a display screen.

The GNSS reception device 29 can detect the current position (e.g., the latitude and the longitude) of the self-driving taxi 5 based on information obtained from a plurality of artificial satellites. Thus, the current position of the self-driving taxi 5 can be acquired by this GNSS reception device 29. As the GNSS reception device 29, for example, a GPS reception device is used. On the other hand, the map data storage device 30 stores map data etc. required for the self-driving taxi 5 to drive autonomously. The various sensors 28, the GNSS reception device 29, the map data storage device 30, the navigation device 31, and the display device 32 are connected to the electronic control unit 23. In addition, the self-driving taxi 5 is equipped with a communication device 33 for communicating with the information processing server 3 and the vehicle dispatch management server 4 through the base station 2 and the communication network 1.

On the other hand, the terminal 6 owned by a user who uses the vehicle dispatch service is configured to be communicable with the information processing server 3, the vehicle dispatch management server 4, and the self-driving taxi 5 through the base station 2 and the communication network 1. Thus, in the information processing system shown in FIG. 1, the information processing server 3, the vehicle dispatch management server 4, the self-driving taxi 5, and the terminal 6 are communicable with one another through the communication network 1. In the example shown in FIG. 1, the communication device 33 of the self-driving taxi 5 and the terminal 6 each include a short-range wireless communication function, and the communication device 33 of the self-driving taxi 5 and the terminal 6 are configured to be communicable with each other by this short-range wireless communication function.

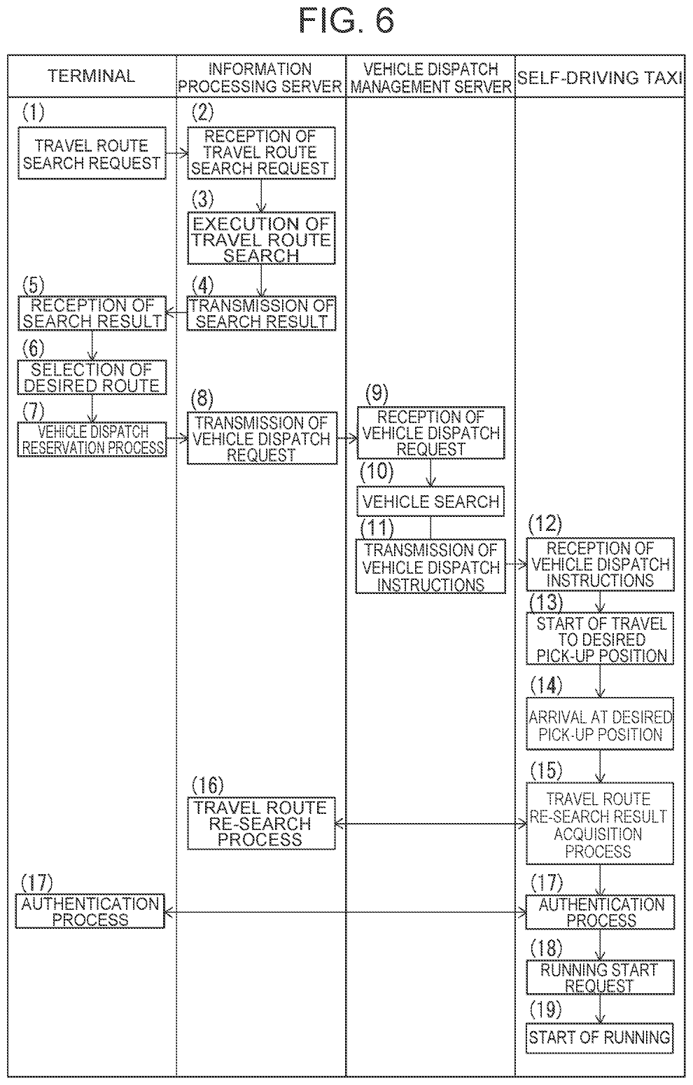

Next, overall flows of the procedure of determining and changing the travel route and the procedure of dispatching and taking the self-driving taxi 5 will be described with reference to FIG. 6. FIG. 6 shows the overall flows of these procedure of determining and changing the travel route and procedure of dispatching and taking the self-driving taxi 5, i.e., an overall flow of information processing executed in an embodiment of the present disclosure. In FIG. 6, interaction among the information processing server 3, the vehicle dispatch management server 4, the self-driving taxi 5, and the terminal 6 are shown. In FIG. 6, a case is shown where a travel route that involves transfer to a regularly operated railroad after taking the self-driving taxi 5 has been selected. Referring to FIG. 6, in (1), a user who uses the vehicle dispatch service (hereinafter referred to simply as a “user”) inputs a place of departure, a time of departure, a destination, a desired time of arrival at the destination, etc. on the terminal 6 using a travel route search application, and makes a travel route search request.

In (2), the information processing server 3 receives this travel route search request, and then in (3), a search for a travel route that meets the requirements is performed in the information processing server 3 based on the received place of departure, time of departure, destination, desired time of arrival at the destination, etc. Next, in (4), the result of the travel route search is transmitted from the information processing server 3 to the terminal 6. In (5), the terminal 6 receives the result of the travel route search, and then in (6), the user selects a desired travel route from among a plurality of searched travel routes on the display screen of the terminal 6 using the travel route search application.

There may be a case where the result of the travel route search in (4) does not include a travel route that involves transfer from the self-driving taxi 5 to the regularly operated railroad. However, the flow of information processing shown in FIG. 6 has been described based on a case where the result of the travel route search in (4) includes a travel route involving transfer from the self-driving taxi 5 to the regularly operated railroad, and where, moreover, the travel route involving transfer from the self-driving taxi 5 to the regularly operated railroad is selected as the desired travel route in (6).

In (6), the travel route involving transfer from the self-driving taxi 5 to the regularly operated railroad is selected, and then in (7), the user registers desired contents of vehicle dispatch consisting of a desired pick-up position, a desired pick-up time, and a desired drop-off position for the self-driving taxi 5 on the display screen of the terminal 6 using a vehicle dispatch reservation application. When the desired contents of vehicle dispatch are registered, a notification that a reservation for vehicle dispatch has been made is transmitted from the terminal 6 to the information processing server 3 along with the registered desired contents of vehicle dispatch and the user's desired travel route. When the information processing server 3 receives from the terminal 6 the notification that a reservation for vehicle dispatch has been made along with the desired contents of vehicle dispatch and the user's desired travel route, the received desired contents of vehicle dispatch and user's desired travel route are stored in the memory 13 of the information processing server 3, and in (8), a vehicle dispatch request is transmitted from the information processing server 3 to the vehicle dispatch management server 4. This vehicle dispatch request includes the user's desired travel route, information about the railroad to which transfer is planned on the user's desired travel route, the desired contents of vehicle dispatch consisting of the desired pick-up position, the desired pick-up time, and the desired drop-off position for the self-driving taxi 5, and a user ID for identifying the user. This vehicle dispatch request can include the user's place of departure, time of departure, destination, and desired time of arrival at the destination that have been received by the information processing server 3 in (2).

In (9), the vehicle dispatch management server 4 receives the vehicle dispatch request. Then in (10), in the vehicle dispatch management server 4, a self-driving taxi 5 that can be dispatched to the user's desired pick-up position at the user's desired pick-up time is searched for among self-driving taxis 5 that are located near the user's desired pick-up position, and the self-driving taxi 5 to be dispatched is selected. In this case, self-driving taxis 5 that are in a vacant state can be search targets, or self-driving taxis 5 that are to be vacant around the user's desired pick-up time based on reservation information can be included in search targets. When the self-driving taxi 5 to be dispatched is selected, in (11), vehicle dispatch instructions are transmitted from the vehicle dispatch management server 4 to the self-driving taxi 5 that has been selected to be dispatched, along with the user's desired travel route, the information about the railroad to which transfer is planned on the user's desired travel route, the desired contents of vehicle dispatch including the pick-up position, the drop-off position, and the pick-up time for the self-driving taxi 5, and the user ID.

In (12), the self-driving taxi 5 receives the vehicle dispatch instructions, and then a running route from the current position to the user's desired pick-up position is generated in the electronic control unit 23 of the self-driving taxi 5 based on the received user's desired pick-up position. Next, in (13), autonomous driving of the self-driving taxi 5 is started, and the self-driving taxi 5 runs along the generated running route so as to arrive at the user's desired pick-up position at the user's desired pick-up time. Thereafter, in (14), the self-driving taxi 5 arrives at the user's desired pick-up position. Then in (15), a travel route re-search result acquisition process is performed, and in (16), a travel route re-search process is performed. The travel route re-search result acquisition process performed in (15) and the travel route re-search process performed in (16) will be described in detail later. To put it briefly, in (15), a plurality of travel routes from the current position that has been searched for in the information processing server 3 is presented.

Next, in (17), a user authentication process is performed using short-range communication between the terminal 6 of the user who has made the reservation for vehicle dispatch and the self-driving taxi 5. This authentication process is performed by, for example, collating the user ID stored in the memory 26 of the self-driving taxi 5 at the time of the vehicle dispatch request and the user ID stored in the terminal 6 of the user who has made the vehicle dispatch request, and when these user IDs match, the user carrying the terminal 6 is authenticated as the user who has made the vehicle dispatch request. As a user authentication process, various authentication processes, such as face authentication, are commonly known, and such a commonly known authentication process can be used as the authentication process in (17).

In (17), the user carrying the terminal 6 is authenticated as the user who has made the vehicle dispatch request, and then the door of the self-driving taxi 5 is opened and the user or two or more persons including the user get in the self-driving taxi 5. Next, when it is determined that picking up of the user or the two or more persons including the user has been completed by a pick-up confirmation device installed in the self-driving taxi 5, the door of the self-driving taxi 5 is closed. Next, in (18), the user selects a desired new travel route from among the plurality of travel routes presented in (15), re-sets the desired drop-off position, and makes a running start request for the self-driving taxi 5. When the running start request for the self-driving taxi 5 is made, a running route from the current position to the re-set user's desired drop-off position is generated in the electronic control unit 23 of the self-driving taxi 5. These processes in (18) will be described in detail later. Next, in (19), autonomous running of the self-driving taxi 5 is started.

Next, configurations that the information processing server 3, the vehicle dispatch management server 4, the self-driving taxi 5, and the terminal 6 respectively have to execute the flow of information processing shown in FIG. 6 will be sequentially described. First, the configuration of the information processing server 3 will be described. The information processing server 3 is formed so as to be communicable with the vehicle dispatch management server 4, the self-driving taxi 5, and the terminal 6 through the communication network 1. On the other hand, the information processing server 3 includes an information reception unit that can receive in real time, through the communication network 1, railroad operation information and railroad delay information from a railroad company as well as road traffic congestion information from a local government etc. The information processing server 3 includes a search request reception unit that receives a travel route search request from the terminal 6 of the user along with the place of departure, the time of departure, the destination, the desired time of arrival at the destination, etc. The information processing server 3 includes a travel route search unit that can search for a plurality of travel routes including a multimodal travel route that uses at least the self-driving taxi 5 and the railroad based on the place of departure, the time of departure, the destination, the desired time of arrival at the destination, etc. received by the search request reception unit.

Further, the information processing server 3 includes a search result transmission unit that transmits the plurality of travel routes searched for by the travel route search unit to the terminal 6 of the user. The information processing server 3 includes a vehicle dispatch reservation reception unit that receives, from the terminal 6 of the user, the desired contents of vehicle dispatch consisting of the desired pick-up position, the desired pick-up time, and the desired drop-off position for the self-driving taxi 5 and a notification that a reservation for vehicle dispatch has been made, along with the user's desired travel route. In the information processing server 3, the user's desired travel route, the desired contents of vehicle dispatch including the pick-up position, the drop-off position, and the pick-up time for the self-driving taxi 5 to be used by the user on the user's desired travel route, and information about the railroad to which transfer is planned on the user's desired travel route have been acquired. The information processing server 3 includes a vehicle dispatch request transmission unit that transmits, to the vehicle dispatch management server 4, a vehicle dispatch request including the user's desired travel route, the desired contents of vehicle dispatch, and the information about the railroad that have been acquired. The information processing server 3 includes an information provision unit that provides the user with various pieces of information other than a plurality of searched travel routes.

Next, the configuration of the vehicle dispatch management server 4 will be described. The vehicle dispatch management server 4 is formed so as to be communicable with the information processing server 3, the self-driving taxi 5, and the terminal 6 through the communication network 1. The vehicle dispatch management server 4 includes a vehicle dispatch request reception unit that receives, from the information processing server 3, the user's desired travel route, the desired contents of vehicle dispatch including the pick-up position, the drop-off position, and the pick-up time for the self-driving taxi 5 to be used by the user, and the information about the railroad to which transfer is planned. The vehicle dispatch management server 4 includes a vehicle search unit that selects a self-driving taxi 5 to be dispatched by searching for a self-driving taxi 5 that can be dispatched to the user's desired pick-up position at the user's desired pick-up time from among self-driving taxis 5 that are located near the user's desired pick-up position. Further, the vehicle dispatch management server 4 includes vehicle dispatch instructions transmission unit that transmits, to the self-driving taxi 5 selected to be dispatched, vehicle dispatch instructions along with the user's desired travel route, the desired contents of vehicle dispatch including the pick-up position, the drop-off position, and the pick-up time for the self-driving taxi 5 to be used by the user, and the information about the railroad to which transfer is planned.

Next, the configuration of the terminal 6 will be described. The terminal 6 includes a communication unit for communicating with the information processing server 3, the vehicle dispatch management server 4, and the self-driving taxi 5 through the communication network 1. The terminal 6 includes a current position acquisition unit formed by, for example, a GPS reception device that can detect the current position (e.g., the latitude and the longitude) of the terminal 6. The terminal 6 has a display screen. It is possible to request a search for a travel route through the terminal 6 by inputting a place of departure, a time of departure, a destination, a desired time of arrival at the destination, etc. on the display screen of the terminal 6 using the travel route search application. The terminal 6 is configured to be able to display, on the display screen of the terminal 6, a plurality of travel routes searched for in the information processing server 3. The terminal 6 allows the user to select a desired travel route from among the plurality of travel routes searched for in the information processing server 3 on the display screen of the terminal 6, and further to make a reservation for dispatch of a self-driving taxi 5 on the display screen of the terminal 6. In this case, a configuration can also be adopted in which a reservation for vehicle dispatch can be directly made to the vehicle dispatch management server 4 on the display screen of the terminal 6 by using the vehicle dispatch reservation application.

Finally, as for the configuration of the self-driving taxi 5, since the overall configuration of the self-driving taxi 5 has already been described with reference to FIG. 4, here, various modes of control executed by the electronic control unit 23 of the self-driving taxi 5 will be described with reference to the functional configuration diagram shown in FIG. 5. Referring to FIG. 5, the self-driving taxi 5 includes a travel route reception unit 40, a running route generation unit 41, an autonomous running control unit 42, a communication unit 43, an authentication unit 44, a travel route re-search result acquisition unit 45, a display control unit 46, and a current location acquisition unit 47. In one embodiment of the information processing device according to the present disclosure, the travel route reception unit 40, the communication unit 43, the travel route re-search result acquisition unit 45, and the display control unit 46 constitute the information processing device. In another embodiment of the information processing device according to the present disclosure, a part of the function that constitute the information processing device is performed by the electronic control unit 10 of information processing server 3.

In FIG. 5, the travel route reception unit 40 receives, from the vehicle dispatch management server 4, the user's desired travel route, the desired contents of vehicle dispatch including the pick-up position, the drop-off position, and the pick-up time for the self-driving taxi 5 to be used by the user, and the information about the railroad to which transfer is planned. In this case, the travel route reception unit 40 can receive these pieces of information etc. also from the information processing server 3. On the other hand, the running route generation unit 41 generates, based on these pieces of information etc., a running route of the self-driving taxi 5 from the current position to the user's desired pick-up position, and a running route of the self-driving taxi 5 from the user's desired pick-up position to the user's desired drop-off position.

The autonomous running control unit 42 controls autonomous running of the self-driving taxi 5 along the generated running route. The communication unit 43 is connected to the communication device 33, and can communicate with the information processing server 3, the vehicle dispatch management server 4, and the terminal 6 through the communication device 33. The authentication unit 44 performs authentication that a person who has got in the self-driving taxi 5 is the user who has made a reservation for dispatch of the self-driving taxi 5. The travel route re-search result acquisition unit 45 acquires a re-search result of re-searched travel routes from the information processing server 3. The display control unit 46 is connected to the display device 32 that has a display screen installed inside the self-driving taxi 5, and contents displayed on the display screen installed inside the self-driving taxi 5 are controlled by the display control unit 46. The current location acquisition unit 47 acquires the current position of the self-driving taxi 5 based on received data received by the GNSS reception device 29.

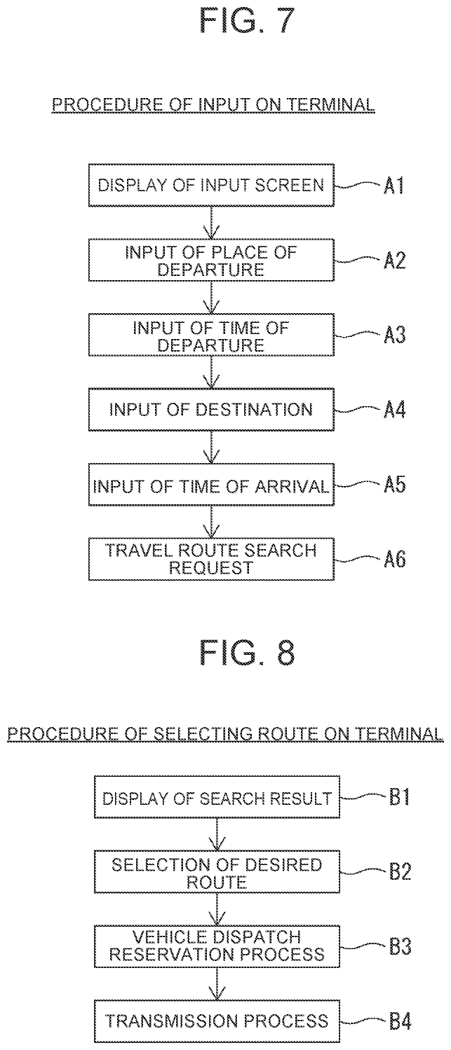

Next, one embodiment for executing the processes shown in (1) to (11) in the flow of FIG. 6 will be described with reference to FIG. 7 to FIG. 10.

FIG. 7 shows the procedure of input on the terminal 6 by the user. Referring to FIG. 7, first, in A1, an input screen for a travel route search is displayed on the display screen of the terminal 6 using the travel route search application. Next, in A2, for example, a place of departure is entered into a field for the place of departure on the input screen. In this case, the place of departure can also be designated in a map displayed on the display screen of the terminal 6. Next, in A3, a time of departure is entered into a field for the time of departure on the input screen. Next, in A4, for example, a destination is entered into a field for the destination on the input screen. Also in this case, the destination can be designated in a map displayed on the display screen of the terminal 6. Next, in A5, a desired time of arrival at the destination is entered into a field for the desired time of arrival on the input screen. Next, in A6, for example, a search request button displayed on the input screen is touched. When the search request button is touched, a travel route search request is transmitted to the information processing server 3 along with the place of departure, the time of departure, the destination, and the desired time of arrival at the destination that have been input.

FIG. 8 shows the procedure of selecting a route on the terminal 6 by the user. Referring to FIG. 8, first, in B1, a search result of a plurality of travel routes transmitted from the information processing server 3 is displayed on the display screen of the terminal 6. Next, in B2, a desired travel route is selected from among the plurality of travel routes. Here, a case will be described where, as the desired travel route, a travel route involving transfer from the self-driving taxi 5 to the regularly operated railroad has been selected. When the desired travel route is selected in B2, in B3, the user registers desired contents of vehicle dispatch consisting of the desired pick-up position, the desired pick-up time, and the desired drop-off position in respective registration fields for the desired pick-up position, the desired pick-up time, and the desired drop-off position for the self-driving taxi 5 on the display screen of the terminal 6 using the vehicle dispatch reservation application. Also in this case, registration of the desired pick-up position and the desired drop-off position can be performed by designating the desired pick-up position and the desired drop-off position in a map displayed on the display screen of the terminal 6. When the desired contents of vehicle dispatch consisting of these desired pick-up position, the desired pick-up time, and the desired drop-off position are registered, in B4, a notification that a reservation for vehicle dispatch has been made is transmitted from the terminal 6 to the information processing server 3 along with the registered desired contents of vehicle dispatch and the user's desired travel route.

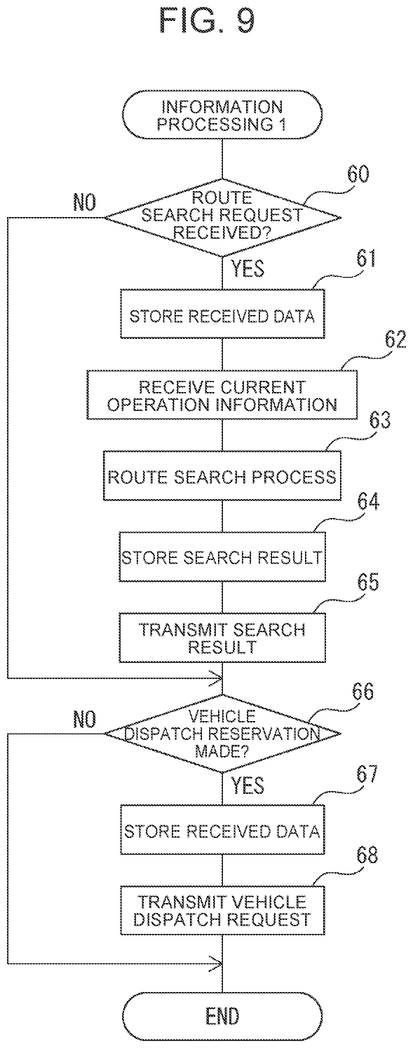

FIG. 9 shows a routine for performing information processing 1, and this routine is executed by interrupt once every certain time in the electronic control unit 10 of the information processing server 3.

Referring to FIG. 9, first, in step 60, it is determined whether a travel route search request has been received from the terminal 6. When it is determined that a travel route search request has been received from the terminal 6, the process moves to step 61, where the received data such as the user's place or departure, time of departure, destination, and desired time of arrival at the destination that have been received along with the travel route search request are stored in the memory 13 of the electronic control unit 10. Next, in step 62, current railroad operation information and current railroad delay information are received from the railroad company, and the received current railroad operation information and current railroad delay information are stored in the memory 13 of the electronic control unit 10. Next, in step 63, a search is performed for a plurality of travel routes that meets the user's requirements. Next, in step 64, the result of the travel route search is stored in the memory 13 of the electronic control unit 10. Next, in step 65, the result of the travel route search is transmitted to the terminal 6. Next, the process moves to step 66. On the other hand, when it is determined in step 60 that a travel route search request has not been received from the terminal 6, the flow jumps to step 66.

In step 66, it is determined whether a notification that a reservation for vehicle dispatch has been made has been received from the terminal 6 along with the desired pick-up position, the desired pick-up time, and the desired drop-off position for the self-driving taxi 5 and the user's desired travel route. When it is determined that a notification that a reservation for vehicle dispatch has been made has been received from the terminal 6, the process moves to step 67, where the desired pick-up position, the desired pick-up time, and the desired drop-off position and the user's desired travel route that have been received are stored in the memory 13 of the electronic control unit 10. Next, in step 68, a vehicle dispatch request including the user's desired travel route, information about the railroad to which transfer is planned on the user's desired travel route, the desired pick-up position, the desired pick-up time, and the desired drop-off position for the self-driving taxi 5, and the user ID for identifying the user is transmitted to the vehicle dispatch management server 4. On the other hand, when it is determined in step 66 that a notification that a reservation for vehicle dispatch has been made has not been received from the terminal 6, the processing cycle is ended.

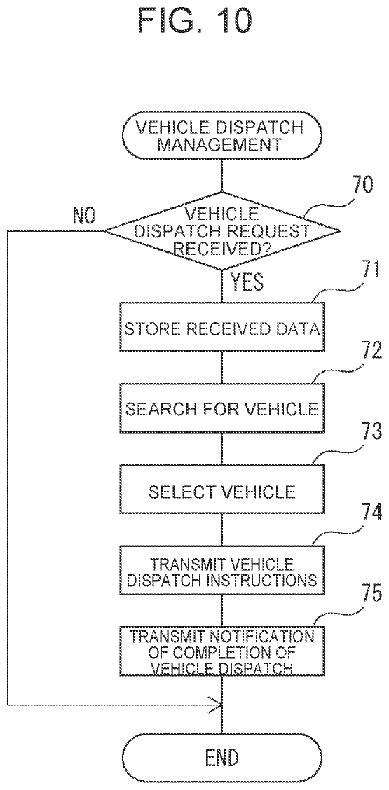

FIG. 10 shows a vehicle dispatch management routine that is executed in the electronic control unit 15 of the vehicle dispatch management server 4, and this routine is repeatedly executed.

Referring to FIG. 10, first, in step 70, it is determined whether a vehicle dispatch request has been received from the information processing server 3. When it is determined that a vehicle dispatch request has not been received from the information processing server 3, the processing cycle is ended. On the other hand, when it is determined that a vehicle dispatch request has been received from the information processing server 3, the process moves to step 71, where the received data including the user's desired travel route, the information about the railroad to which transfer is planned on the user's desired travel route, the desired pick-up position, the desired pick-up time, and the desired drop-off position for the self-driving taxi 5, and the user ID that have been received are stored in the memory 18 of the electronic control unit 15.

Next, in step 72, a self-driving taxi 5 that can be dispatched to the user's desired pick-up position at the user's desired pick-up time is searched for among self-driving taxis 5 that are located near the user's desired pick-up position. In this case, self-driving taxis 5 that are in a vacant state can be search targets, or self-driving taxis 5 that are to be vacant around the user's desired pick-up time based on reservation information can also be included in search targets. Next, in step 73, a self-driving taxi 5 to be dispatched is selected from among the self-driving taxis 5 that are search targets. When the self-driving taxi 5 to be dispatched is selected, in step 74, vehicle dispatch instructions are transmitted from the vehicle dispatch management server 4 to the self-driving taxi 5 that has been selected to be dispatched, along with the user's desired travel route, the information about the railroad to which transfer is planned on the user's desired travel route, the desired contents of vehicle dispatch including the pick-up position, the drop-off position, and the pick-up time for the self-driving taxi 5, and the user ID. Next, in step 75, a notification of completion of vehicle dispatch is transmitted to the terminal 6.

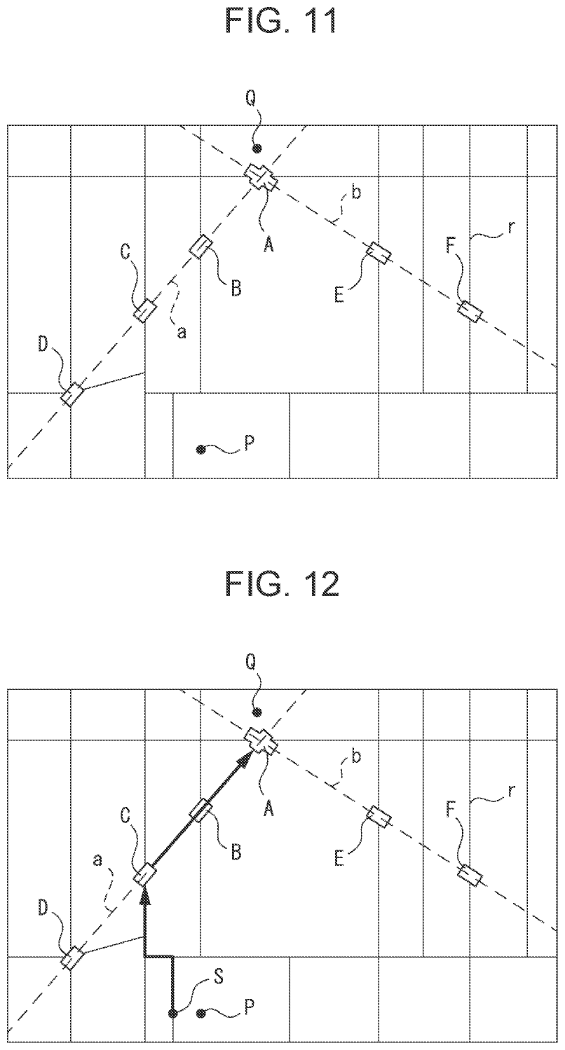

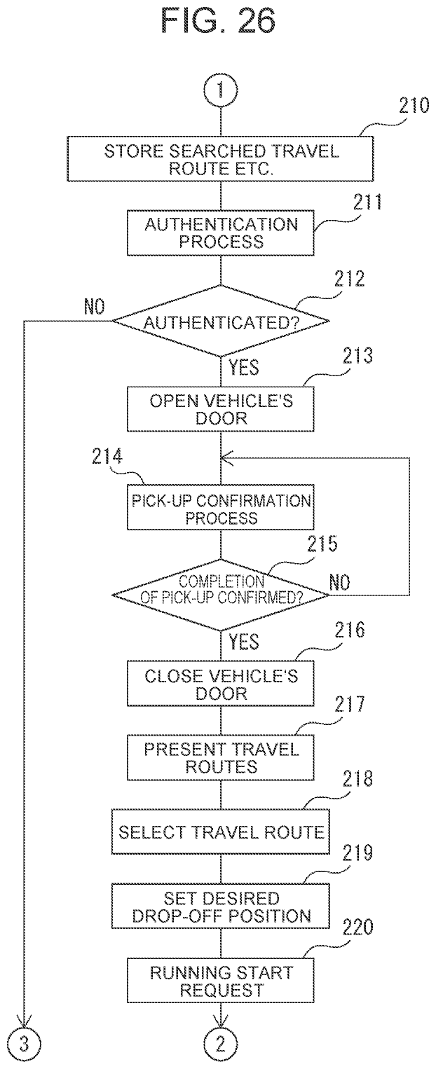

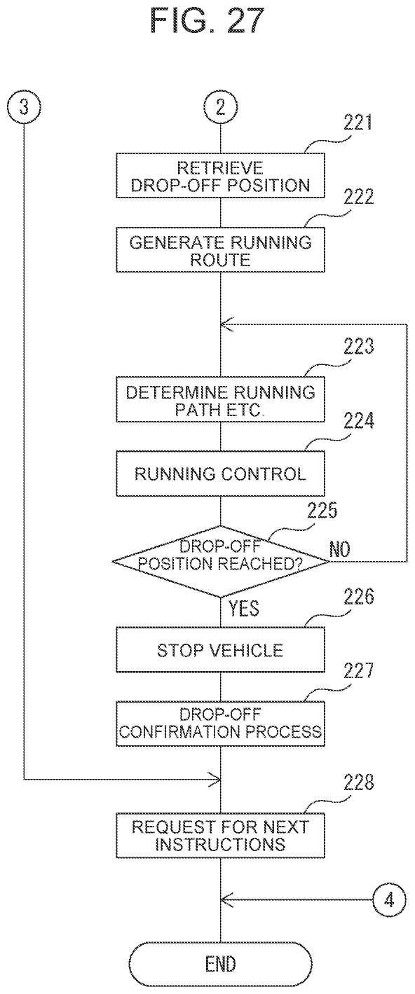

When the vehicle dispatch instructions are transmitted from the vehicle dispatch management server 4 to the self-driving taxi 5 that has been selected to be dispatched, the processes shown in (12) to (19) in the flow of FIG. 6 are executed. Therefore, next, one embodiment for executing the processes shown in (12) to (19) in the flow of FIG. 6 will be described with reference to FIG. 11 to FIG. 27.

In (12) of the flow shown in FIG. 6, when the self-driving taxi 5 selected to be dispatched receives the vehicle dispatch instructions from the vehicle dispatch management server 4, the self-driving taxi 5 selected to be dispatched first runs autonomously toward the user's desired pick-up position along the user's desired travel route, and when the user etc. get in the self-driving taxi 5 at the desired pick-up position, the self-driving taxi 5 starts running autonomously toward the user's desired drop-off position, i.e., the travel destination of the self-driving taxi 5 for transfer to the railroad.

In this case, as one example, the operating state of the railroad and the degree of congestion on the road are different between the point when the user has selected a desired travel route and made a reservation for dispatch of the self-driving taxi 5 using the terminal 6 and the point when the self-driving taxi 5 selected to be dispatched has arrived at the user's desired pick-up position. Thus, in some cases, even though a railroad delay or road congestion did not exist at the point when the user has selected a desired travel route and made a reservation for dispatch of the self-driving taxi 5 using the terminal 6, a railroad delay or road congestion may exist at the point when the self-driving taxi 5 selected to be dispatched has arrived at the user's desired pick-up position. Therefore, if the self-driving taxi 5 runs from the user's desired pick-up position to the user's desired drop-off position, i.e., the travel destination of the self-driving taxi 5 for transfer to the railroad, the influence of the railroad delay or the road congestion may be so significant that the user fails to arrive at the final destination on a scheduled time.

In such a case, if the desired travel route selected by the user is changed to a travel route that is as little affected by the railroad delay or the road congestion as possible, and the travel destination of the self-driving taxi 5 for transfer to the railroad is changed, efficient travel can be provided to the occupant of the vehicle. In the embodiment of the present disclosure, therefore, when there is a railroad delay or road congestion, the desired travel route selected by the user is changed to a travel route that is as little affected by the railroad delay or the road congestion as possible, and the travel destination of the self-driving taxi 5 for transfer to the railroad is changed. Processes of thus changing the travel route and the travel destination of the self-driving taxi 5 are performed in (16) and (15) of the flow of FIG. 6. Therefore, before a routine for performing the processes of (12) to (19) of the flow of FIG. 6 is described, the processes performed in (16) and (15) of FIG. 6 will be described first with reference to FIG. 11 to FIG. 18.

FIG. 11 to FIG. 18 show some specific examples about changes of the travel route and the travel destination of the self-driving taxi 5 that are made in (16) and (15) of FIG. 6. First, referring to FIG. 11 that shows one example of a road map, dashed lines a, b represent two railroad lines, and solid lines r represent roads. Reference sign A denotes a station shared by the lines a, b, and reference signs B, C, D denote stations in the line a, and reference signs E, F denote stations in the line b. In FIG. 11, reference sign P denotes the user's place of departure, and reference sign Q denotes the user's final destination. The railroad lines a, b, the stations A, B, C, D, E, F, the roads r, the user's place of departure P, and the user's final destination Q shown in FIG. 11 are the same in the other drawings, FIG. 12 to FIG. 18.

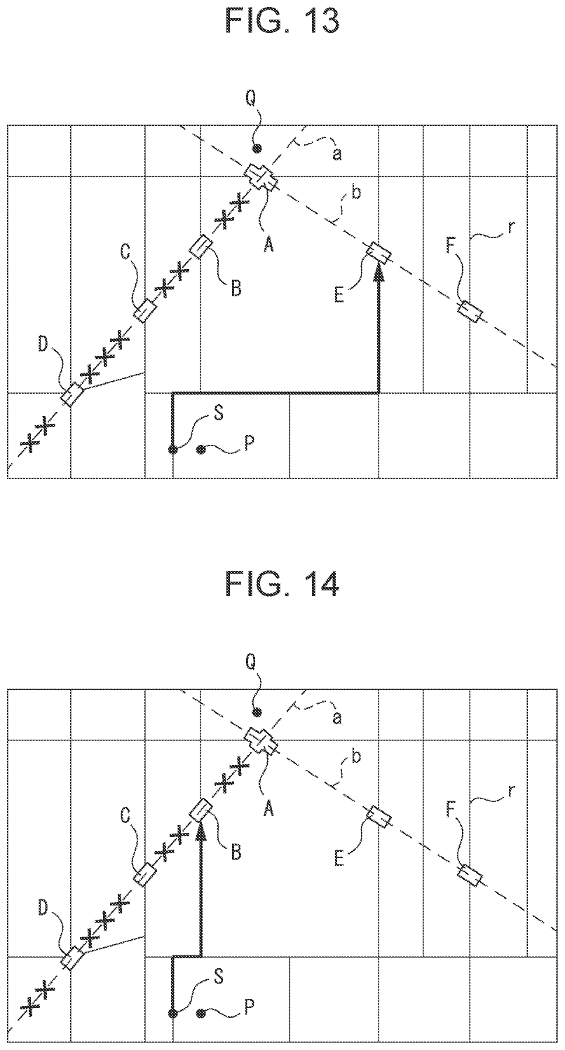

Next, referring to FIG. 12, the thick arrows represent a desired travel route that the user has selected from among a plurality of travel routes when making a reservation for vehicle dispatch. In FIG. 12, reference sign S denotes the user's desired pick-up position. This user's desired pick-up position S is the same in FIG. 13 to FIG. 18. In the example shown in FIG. 12, the user's desired travel route is a route of, to get from the place of departure P to the final destination Q, traveling from the desired pick-up position S to the station C in the line a by the self-driving taxi 5 and traveling from the station C to the station A closest to the final destination Q by the railroad of the line a. In this case, the station C is the travel destination of the self-driving taxi 5, and the self-driving taxi 5 picks up the user at the user's desired pick-up position S and then runs autonomously to the travel destination of the self-driving taxi 5.

Next, referring to FIG. 13 to FIG. 15, the cross marks in these drawings indicate existence of a railroad delay, and thus FIG. 13 to FIG. 15 show cases where a railroad delay exists between the stations A and B in the line a, between the stations B and C in the line a, between the stations C and D in the line a, etc. In the embodiment according to the present disclosure, when a railroad delay thus exists, a travel route that mitigates the influence of the railroad delay is regenerated. In this case, in the example shown in FIG. 13, a route of traveling from the desired pick-up position S to the station E in the line b by the self-driving taxi 5 (thick arrow) and traveling from the station E to the station A closest to the final destination Q by the railroad of the line b is generated as a new travel route. In this case, a route that uses another line b different from the line a in which a delay exists is generated as a new travel route. In this case, the station E becomes the travel destination of the self-driving taxi 5, and thus the travel destination of the self-driving taxi 5 has been changed.

On the other hand, in the example shown in FIG. 14, a route of traveling from the desired pick-up position S to the station B in the line a by the self-driving taxi 5 (thick arrow) and traveling from the station B to the station A closest to the final destination Q by the railroad of the line a is generated as a new travel route. In this case, a route that shortens the travel distance in the line a where a delay exists is generated as a new travel route. In this case, since the line a where a delay exists is used only between the stations A and B, that is, the travel distance in the line a where a delay exists becomes shorter, the influence of the railroad delay is mitigated. In this case, the station B becomes the travel destination of the self-driving taxi 5, and thus, also in this case, the travel destination of the self-driving taxi 5 has been changed.

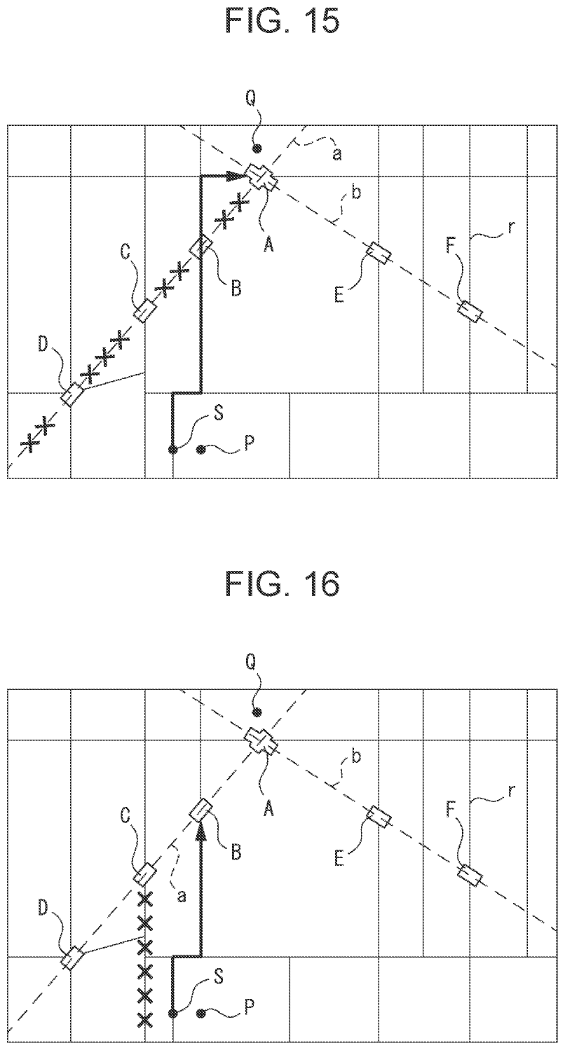

On the other hand, in the example shown in FIG. 15, a route of traveling from the desired pick-up position S to the station A closest to the final destination Q by the self-driving taxi 5 (thick arrow), i.e., a route of traveling by the self-driving taxi 5 to the station A in the line a where a delay exists is generated as a new route. In this case, the station A becomes the travel destination of the self-driving taxi 5, and thus, also in this case, the travel destination of the self-driving taxi 5 has been changed.

Next, referring to FIG. 16 to FIG. 18, the cross marks in these drawings indicate existence of traffic congestion on the roads r, and thus FIG. 16 to FIG. 18 show cases where traffic congestion exists on the user's desired travel route. In the embodiment according to the present disclosure, when congestion thus exists, a travel route that mitigates the influence of the congestion is regenerated. In this case, in the example shown in FIG. 16, a route of traveling from the desired pick-up position S to the station B in the line a by the self-driving taxi 5 (thick arrow) and traveling from the station B to the station A closest to the final destination Q by the railroad of the line a is generated as a new travel route. In this case, the station B becomes the travel destination of the self-driving taxi 5, and thus the travel destination of the self-driving taxi 5 has been changed. In this way, in this case, a route that leads to the travel destination (station B) different from the travel destination (station C) on the user's desired travel route, without passing the road r where congestion exists, is generated as a new travel route.

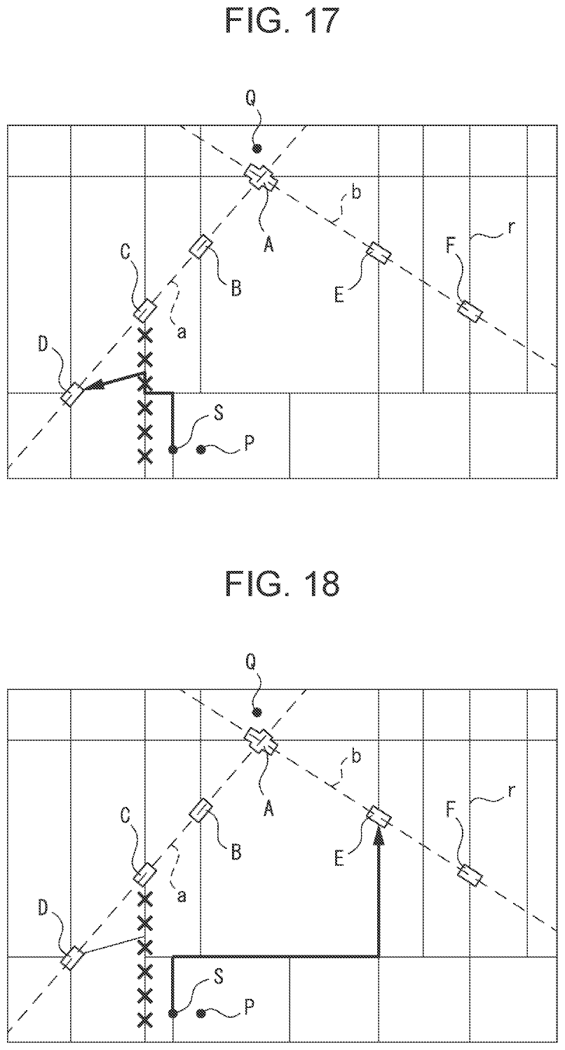

On the other hand, in the example shown in FIG. 17, a route of traveling from the desired pick-up position S to the station D in the line a by the self-driving taxi 5 (thick arrow) and traveling from the station D to the station A closest to the final destination Q by the railroad of the line a is generated as a new travel route. In this case, a route that shortens the travel distance on the road where traffic congestion exists is generated as a new travel route. In this case, since only part of the road where congestion exists is passed, that is, the travel distance on the road where congestion exists becomes shorter, the influence of the congestion is mitigated. In this case, the station D becomes the travel destination of the self-driving taxi 5, and thus, also in this case, the travel destination of the self-driving taxi 5 has been changed.

On the other hand, in the example shown in FIG. 18, a route of traveling from the desired pick-up position S to the station E in the line b by the self-driving taxi 5 (thick arrow) and traveling from the station E to the station A closest to the final destination Q by the railroad of the line b is generated as a new route. That is, a route that uses another line b different from the line a that is used on the user's desired travel route, without passing the road r where congestion exists, is generated as a new travel route. In this case, the station E becomes the travel destination of the self-driving taxi 5, and thus, also in this case, the travel destination of the self-driving taxi 5 has been changed. In this way, in this case, a route that leads to the travel destination (station E) different from the travel destination (station C) on the user's desired travel route, without passing the road r where congestion exists, is generated as a new travel route.

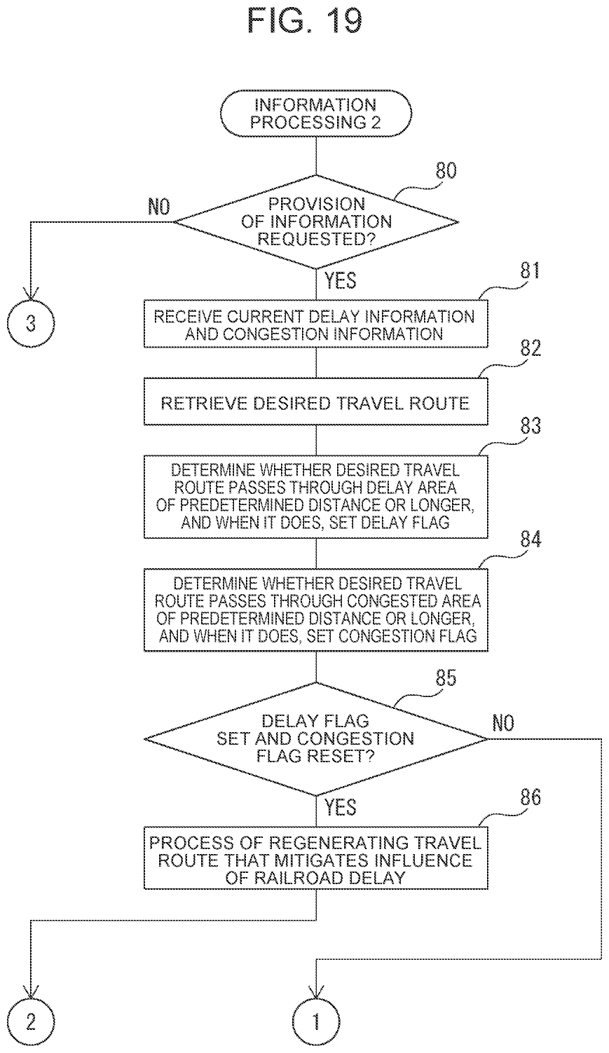

The new travel routes shown in FIG. 13 to FIG. 18 are searched for in the information processing server 3 using a travel route search routine when a request for provision of information about a new travel route is made from the self-driving taxi 5 to the information processing server 3 in (15) and (16) of FIG. 6. One example of this travel route search routine is shown in FIG. 19 to FIG. 24 as information processing 2. The routine shown as the information processing 2 in FIG. 19 to FIG. 24 is executed by interrupt once every certain time in the electronic control unit 10 of the information processing server 3. In the following, this routine will be described.

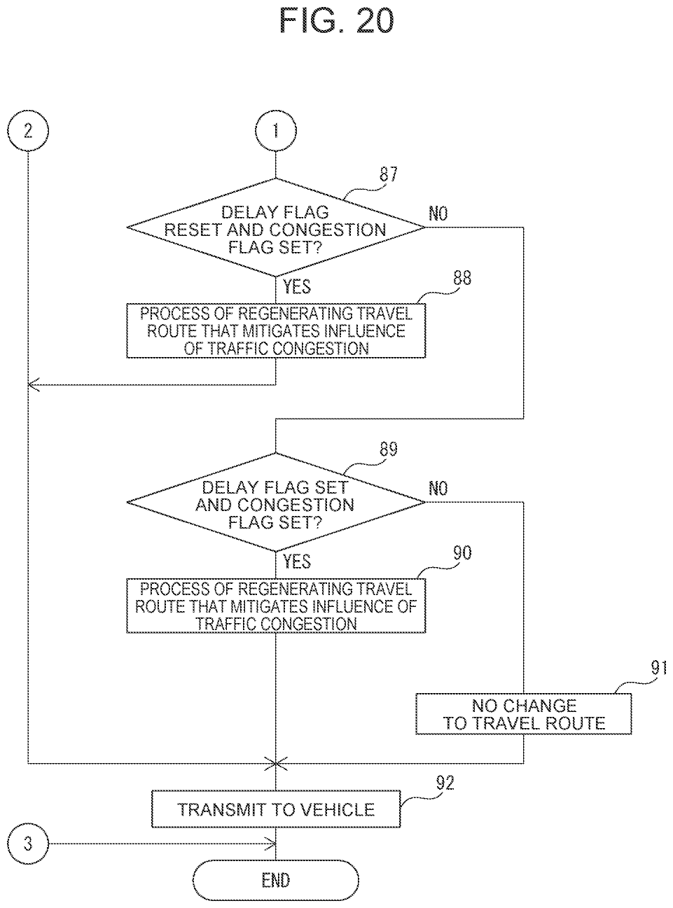

Referring to FIG. 19 and FIG. 20, first, it is determined in step 80 whether a request for provision of information about a new travel route has been made from the self-driving taxi 5 to the information processing server 3. This request for provision of information about a new travel route is issued when the self-driving taxi 5 arrives at the user's desired pick-up position S. When it is determined that a request for provision of information about a new travel route has not been made from the self-driving taxi 5 to the information processing server 3, the processing cycle is ended. On the other hand, when it is determined that a request for provision of information about a new travel route has been made from the self-driving taxi 5 to the information processing server 3, the process moves to step 81, where current railroad delay information is received from the railroad company and current road traffic congestion information is received from the local government etc., and the received contents are stored in the memory 13 of the electronic control unit 10.

Next, in step 82, the user's desired travel route stored in the memory 13 of the electronic control unit 10 is retrieved. Next, in step 83, it is determined whether the user's desired travel route passes through a railroad delay area of a predetermined distance or longer, and when it is determined that the user's desired travel route passes through a railroad delay area of the predetermined distance or longer, a delay flag is set. On the other hand, when it is determined that the user's desired travel route does not pass through a railroad delay area of the predetermined distance or longer, the delay flag is reset. The aforementioned predetermined distance for a railroad delay area is, for example, 100 m.

Next, in step 84, it is determined whether the user's desired travel route passes through a congested area of a predetermined distance or longer, and when it is determined that the user's desired travel route passes through a congested area of the predetermined distance or longer, a congestion flag is set. On the other hand, when it is determined that the user's desired travel route does not pass through a congested area of the predetermined distance or longer, the congestion flag is reset. The aforementioned predetermined distance for a congested area is, for example, 50 m.

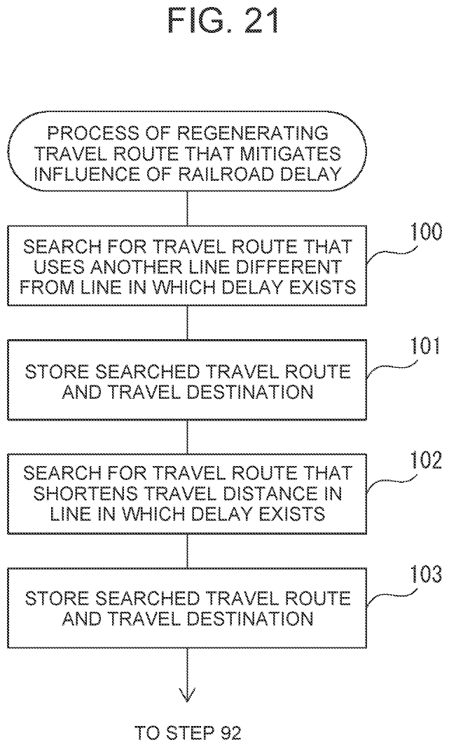

Next, in step 85, it is determined whether the delay flag has been set and that the congestion flag has been reset. When it is determined that the delay flag has been set and that the congestion flag has been reset, i.e., when traffic congestion does not exist but a railroad delay exists, the process moves to step 86, where a process of regenerating a travel route that mitigates the influence of the railroad delay is performed. This process of regenerating a travel route that mitigates the influence of the railroad delay is shown in FIG. 21.

Referring to FIG. 21, in step 100, a search for a travel route that uses another line different from the line where a delay exists is performed based on the current railroad delay information. In this case, for example, a travel route like the one shown in FIG. 13 is searched for. When a travel route has been searched for, the process moves to step 101, where the searched travel route and the travel destination of the self-driving taxi 5 (the station E in FIG. 13) are stored in the memory 13 of the electronic control unit 10.

Next, in step 102, a search for a travel route that shortens the travel distance in the line where a delay exists is performed based on the current railroad delay information. In this case, for example, a travel route like the one shown in FIG. 14 is searched for. Further, in this case, a travel route like the one shown in FIG. 15 is searched for as a case where the travel distance in the line where a delay exists becomes shortest, i.e., the travel distance becomes zero. When a travel route has been searched for, the process moves to step 103, where the searched travel route and the travel destination of the self-driving taxi 5 (the station B in FIG. 14, the station A in FIG. 15) are stored in the memory 13 of the electronic control unit 10. Next, the process moves to step 92 of FIG. 20.

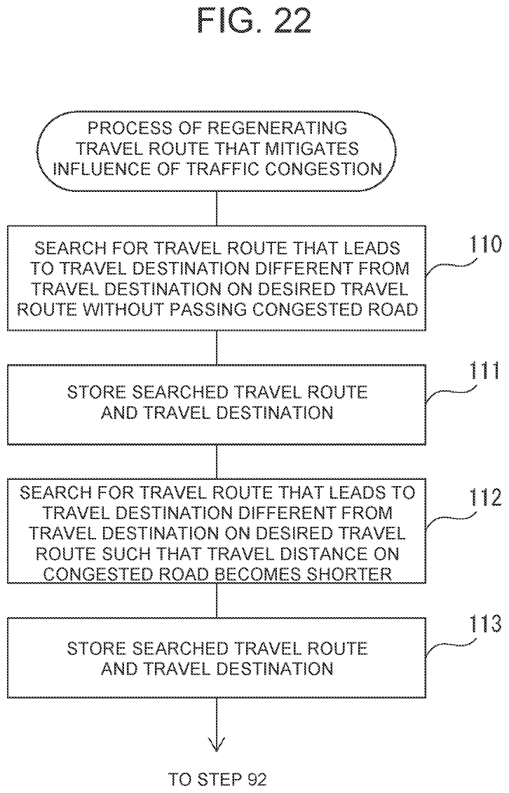

Returning to FIG. 19 and FIG. 20 again, when it is determined in step 85 that the delay flag has not been set and that the congestion flag has not been reset, the process moves to step 87. In step 87, it is determined whether the delay flag has been reset and that the congestion flag has been set. When it is determined that the delay flag has been reset and that the congestion flag has been set, i.e., when a railroad delay does not exist but traffic congestion exists, the process moves to step 88, where a process of regenerating a travel route that mitigates the influence of the traffic congestion is performed. This process of regenerating a travel route that mitigates the influence of the traffic congestion is shown in FIG. 22.

Referring to FIG. 22, in step 110, a search for a travel route that leads to a travel destination different from the travel destination of the self-driving taxi 5 on the user's desired travel route without passing the congested road is performed based on the current road traffic congestion information. In this case, for example, a travel route like the one shown in FIG. 16 and a travel route like the one shown in FIG. 18 are searched for. When a travel route has been searched for, the process moves to step 111, where the searched travel route and the travel destination of the self-driving taxi 5 (the station B in FIG. 16, the station E in FIG. 18) are stored in the memory 13 of the electronic control unit 10.

Next, in step 112, a search for a travel route that leads to a travel destination different from the travel destination of the self-driving taxi 5 on the user's desired travel route such that the travel distance on the congested road becomes shorter is performed based on the road traffic congestion information. In this case, for example, a travel route like the one shown in FIG. 17 is searched for. When a travel route has been searched for, the process moves to step 113, where the searched travel route and the travel destination of the self-driving taxi 5 (the station D in FIG. 17) are stored in the memory 13 of the electronic control unit 10. Next, the process moves to step 92 of FIG. 20.

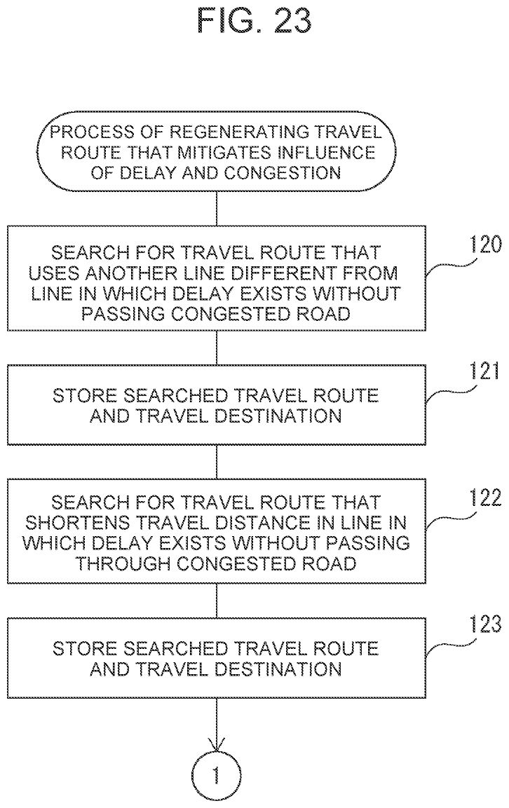

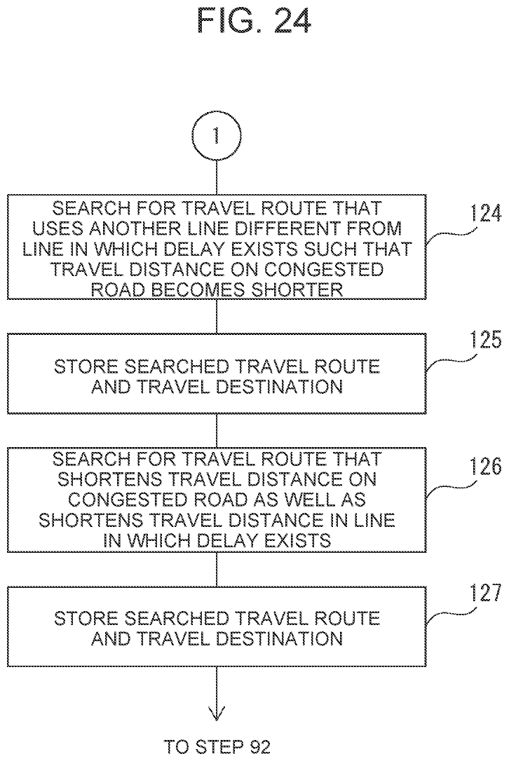

Returning to FIG. 19 and FIG. 20 again, when it is determined in step 87 that the delay flag has not been reset and that the congestion flag has not been set, the process moves to step 89. In step 89, it is determined whether the delay flag has been set and that the congestion flag has been set. When it is determined that the delay flag has been set and that the congestion flag has been set, i.e., when a railroad delay and traffic congestion exist, the process moves to step 90, where a process of regenerating a travel route that mitigates the influence of the railroad delay and the traffic congestion is performed. This process of regenerating a travel route that mitigates the influence of the railroad delay and the traffic congestion is shown in FIG. 23 and FIG. 24.

Referring to FIG. 23 and FIG. 24, in step 120, a search for a travel route that uses another line different from the line where the delay exists without passing the congested road is performed based on the current railroad delay information and road traffic congestion information. In this case, for example, travel routes like those shown in FIG. 13 and FIG. 18 are searched for. When a travel route has been searched for, the process moves to step 121, where the searched travel route and the travel destination of the self-driving taxi 5 (the station E in FIG. 13 and FIG. 18) is stored in the memory 13 of the electronic control unit 10.

Next, in step 122, a search for a travel route that shortens the travel distance in the line where the delay exists without passing the congested road is performed based on the current railroad delay information and road traffic congestion information. In this case, for example, travel routes like those shown in FIG. 14 and FIG. 16 and a travel route like the one shown in FIG. 15 are searched for. When a travel route has been searched for, the process moves to step 123, where the searched travel route and the travel destination of the self-driving taxi 5 (the station B in FIG. 14 and FIG. 16, the station A in FIG. 15) are stored in the memory 13 of the electronic control unit 10.

Next, in step 124, a search for a travel route that uses another line different from the line where the delay exists such that the travel distance on the congested road becomes shorter is performed based on the current railroad delay information and road traffic congestion information. In this case, when there are any applicable travel routes, an applicable travel route is searched for. When a travel route has been searched for, the process moves to step 125, where the searched travel route and the travel destination of the self-driving taxi 5 are stored in the memory 13 of the electronic control unit 10.

Next, in step 126, a search for a travel route that shortens the travel distance on the congested road as well as the travel distance in the line where the delay exists is performed based on the current railroad delay information and road traffic congestion information. In this case, when there are any applicable travel routes, an applicable travel route is searched for. When a travel route has been searched for, the process moves to step 127, where the searched travel route and the travel destination of the self-driving taxi 5 are stored in the memory 13 of the electronic control unit 10. Next, the process moves to step 92 of FIG. 20.

Returning to FIG. 19 and FIG. 20 again, when it is determined in step 89 that the delay flag has not been set and that the congestion flag has not been set, i.e., when neither a railroad delay nor traffic congestion exists, the process moves to step 91 and no change is made to the travel route. Next, the process moves to step 92. In step 92, all the travel routes searched for in steps 100 and 102 (FIG. 21), steps 110 and 112 (FIG. 22), and steps 120, 122, 124, and 126 (FIG. 23 and FIG. 24) and the travel destinations of the self-driving taxi 5 are transmitted to the self-driving taxi 5.

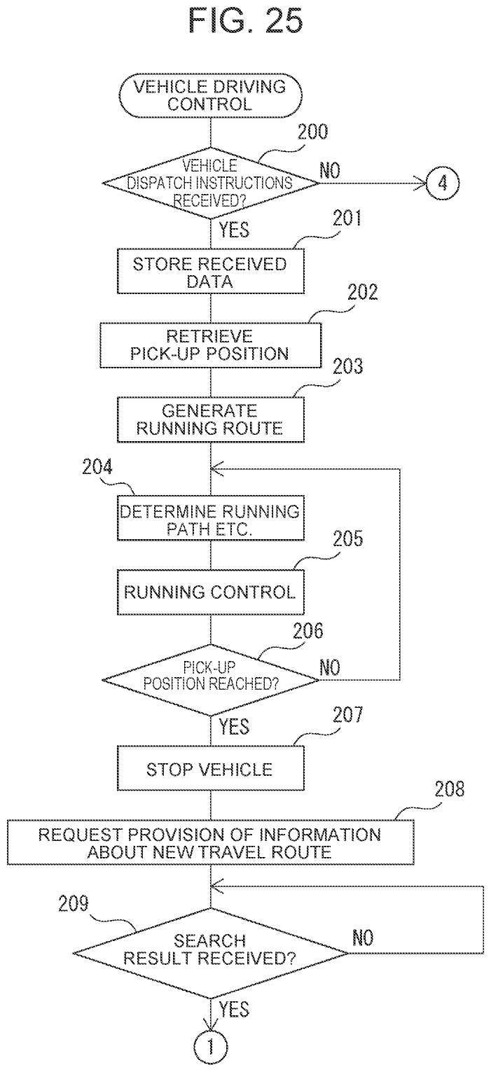

FIG. 25 to FIG. 27 show a driving control routine of the self-driving taxi that the electronic control unit 23 of the self-driving taxi 5 selected to be dispatched executes to perform the processes shown in (12) to (19) except for (16) in the flow of FIG. 6. This routine is repeatedly executed.

Referring to FIG. 25 to FIG. 27, first, in step 200, it is determined whether vehicle dispatch instructions have been received from the vehicle dispatch management server 4. When it is determined that vehicle dispatch instructions have not been received from the vehicle dispatch management server 4, the processing cycle is ended. On the other hand, when it is determined that vehicle dispatch instructions have been received from the vehicle dispatch management server 4, the process moves to step 201, where the received data including the user's desired travel route, information about the railroad to which transfer is planned on the user's desired travel route, the desired pick-up position, the desired pick-up time, and the desired drop-off position for the self-driving taxi 5, and the user ID are stored in the memory 26 of the electronic control unit 23.

Next, in step 202, the user's desired pick-up position is retrieved from the memory 26. Next, in step 203, based on the current position of the self-driving taxi 5 acquired by the GNSS reception device 29 and the user's desired pick-up position retrieved from the memory 26, a running route of the self-driving taxi 5 from the current position to the user's desired pick-up position is created by the navigation device 31. Next, in step 204, based on detection results of the sensors such as the cameras that photograph the front side etc. of the self-driving taxi 5, the lidar, and the radar, a running path and a running speed of the self-driving taxi 5 such that the self-driving taxi 5 does not come into contact with other vehicles or pedestrians are determined. Next, in step 205, running control of the self-driving taxi 5 is performed based on the determined running path and running speed.

Next, in step 206, it is determined whether the self-driving taxi 5 has reached the user's desired pick-up position. When it is determined that the self-driving taxi 5 has not reached the user's desired pick-up position, the flow returns to step 204, where autonomous driving of the self-driving taxi 5 is continued. On the other hand, when it is determined in step 206 that the self-driving taxi 5 has reached the user's desired pick-up position, the process moves to step 207, where the self-driving taxi 5 is stopped. Next, in step 208, a request for provision of information about a new travel route is transmitted to the information processing server 3. When the information processing server 3 receives this request for provision of information about a new travel route, as described above, a new travel route that mitigates the influence of one or both of a railroad delay and traffic congestion is searched for in the information processing server 3 by the information processing 2 shown in FIG. 19 to FIG. 24. When the search process is completed, all the searched travel routes and the travel destinations of the self-driving taxi 5 are transmitted from the information processing server 3 to the self-driving taxi 5.

In step 209, reception of the search result, i.e., all the searched travel routes and the travel destinations of the self-driving taxi 5, from the information processing server 3 is waited for, and when the search result is received from the information processing server 3, the process moves to step 210, where the search result received from the information processing server 3, i.e., all the searched travel routes and the travel destinations of the self-driving taxi 5 are stored in the memory 26 of the self-driving taxi 5. Next, the process moves to step 211. In the embodiment according to the present disclosure, the search result, i.e., all the searched travel routes and the travel destinations of the self-driving taxi 5 are acquired from the information processing server 3 when the self-driving taxi 5 reaches the user's desired pick-up position and stops. Alternatively, a configuration can also be adopted in which the search result, i.e., all the searched travel routes and the travel destinations of the self-driving taxi 5 are acquired from the information processing server 3 before the self-driving taxi 5 reaches the user's desired pick-up position, or after the self-driving taxi 5 reaches the user's desired pick-up position and the user gets in the self-driving taxi 5.

In step 211, a user authentication process is performed using short-range communication between the terminal 6 of the user who has made a reservation for vehicle dispatch and the self-driving taxi 5. This authentication process is performed by, for example, collating the user ID stored in the memory 26 of the self-driving taxi 5 at the time of the vehicle dispatch request and the user ID stored in the terminal 6 of the user who has made the vehicle dispatch request, and when these user IDs match, the user carrying the terminal 6 is authenticated as the user who has made the vehicle dispatch request. As the user authentication process, various authentication processes, such as face authentication, are commonly known, and such a commonly known authentication process can be used as the authentication process in step 211.

Next, in step 212, it is determined whether the user carrying the terminal 6 has been authenticated as the user who has made the vehicle dispatch request by the authentication process in step 211. When the user carrying the terminal 6 has not been authenticated as the user who has made the vehicle dispatch request by the authentication process, the flow jumps to step 228, where a request for instructions about the next action is made to the vehicle dispatch management server 4. In this case, for example, the self-driving taxi 5 is moved by autonomous driving to a desired pick-up position of another user who has made a vehicle dispatch request. On the other hand, when the user carrying the terminal 6 has been authenticated as the user who has made the vehicle dispatch request by the authentication process, the process moves to step 213, where the door of the self-driving taxi 5 is opened. When the door of the self-driving taxi 5 is opened, the user who has made the vehicle dispatch request alone or two or more persons including the user who has made the vehicle dispatch request get in the self-driving taxi 5.

Next, in step 214, a pick-up confirmation process of confirming that picking up of the user who has made the vehicle dispatch request or the two or more persons including the user who has made the vehicle dispatch request by the self-driving taxi 5 has been completed is performed. This pick-up confirmation process is performed by the pick-up confirmation device installed in the self-driving taxi 5, for example, through analysis of an image of a pick-up confirmation camera that photographs the inside of the vehicle cabin. Next, in step 215, it is determined whether it has been confirmed that picking up of the user who has made the vehicle dispatch request or the two or more persons including the user who has made the vehicle dispatch request by the self-driving taxi 5 has been completed. When it is determined that completion of picking up has not been confirmed, the flow returns to step 214, where the pick-up confirmation process of confirming completion of picking up is continued. On the other hand, when it is determined in step 215 that completion of picking up has been confirmed, the process moves to step 216.

In step 216, the door of the self-driving taxi 5 is closed. When the door of the self-driving taxi 5 is closed, the process moves to step 217, where the search result received from the information processing server 3, i.e., all the searched travel routes and the travel destinations of the self-driving taxi 5 are presented to occupants including the user. For example, the search result received from the information processing server 3, i.e., all the searched travel routes and the travel destinations of the self-driving taxi 5 are displayed on the display screen of the display device 32. In this case, the search result can be displayed on the display screen of the display device 32 in various forms. For example, the travel routes and the travel destinations of the self-driving taxi 5 can be displayed on the display screen of the display device 32 in the form of a list. It is also possible to display a map like the one shown in FIG. 11 on the display screen of the display device 32, and to display, in the displayed map, a plurality of new travel routes like those shown in FIG. 12 to FIG. 18 each in a different color and the travel destinations of the self-driving taxi 5 in association with the travel routes.

When all the searched travel routes and the travel destinations of the self-driving taxi 5 are presented to the occupants including the user, the process moves to step 218, where a desired travel route is selected from among the presented travel routes by the occupants including the user. When the travel route is selected, the process moves to step 219, where a desired drop-off position at the travel destination of the self-driving taxi 5 on the selected travel route is set by the occupants including the user. The selected travel route and the set desired drop-off position are stored in the memory 26 of the self-driving taxi 5. In the embodiment according to the present disclosure, the configuration in which a plurality of travel routes is presented to the occupants including the user is adopted, but a configuration can also be adopted in which one travel route is automatically selected in the information processing server 3 or the self-driving taxi 5 and the selected travel route is presented to the occupants including the user. When it is determined in the information processing server 3 that there is no change to the travel route, a notification that there is no change to the travel route is displayed, for example, on the display screen of the display device 32.

Next, in step 220, a running start request for the self-driving taxi 5 is made. This running start request for the self-driving taxi 5 is made, for example, as the user having got in the vehicle touches a running start button displayed on the display screen of the display device 32 in the self-driving taxi 5. When the running start request for the self-driving taxi 5 is made, the process moves to step 221, where the user's desired drop-off position is retrieved from the memory 26. Next, in step 222, based on the current position of the self-driving taxi 5 acquired by the GNSS reception device 29 and the user's desired drop-off position retrieved from the memory 26, a running route of the self-driving taxi 5 from the current position to the user's desired drop-off position is created by the navigation device 31.

Next, in step 223, based on detection results of the cameras that photograph the front side etc. of the self-driving taxi 5, the lidar, and the radar, a running path and a running speed of the self-driving taxi 5 such that the self-driving taxi 5 does not come into contact with other vehicles or pedestrians are determined. Next, in step 224, running control of the self-driving taxi 5 is performed in accordance with the determined running path and running speed. Next, in step 225, it is determined whether the self-driving taxi 5 has reached the user's desired drop-off position. When it is determined that the self-driving taxi 5 has not reached the user's desired drop-off position, the flow returns to step 223, where autonomous driving of the self-driving taxi 5 is continued. On the other hand, when it is determined in step 225 that the self-driving taxi 5 has reached the user's desired drop-off position, the process moves to step 226, where the self-driving taxi 5 is stopped.

Next, in step 227, a drop-off confirmation process of confirming that dropping off of the user or the two or more persons including the user riding in the vehicle by the self-driving taxi 5 has been completed is performed. This drop-off confirmation process is performed by a drop-off confirmation device installed in the self-driving taxi 5, for example, through analysis of an image of a drop-off confirmation camera that photographs the inside of the vehicle cabin. When completion of dropping off is confirmed, the door of the self-driving taxi 5 is closed. Next, in step 228, a request for instructions about the next action is made to the vehicle dispatch management server 4.

Thus, in the embodiment according to the present disclosure, when a request for provision of information about a new travel route is transmitted from the self-driving taxi 5 to the information processing server 3, a search for a new travel route that mitigates the influence of one or both of a delay and congestion is performed in the information processing server 3. When the search process is completed, all the searched travel routes and the travel destinations of the self-driving taxi 5 are transmitted from the information processing server 3 to the self-driving taxi 5. In the embodiment according to the present disclosure, therefore, the information processing server 3 includes a reception unit that receives a request for provision of information about a new travel route of the self-driving taxi 5, a travel route search unit that searches for a new travel route that mitigates the influence of one or both of a railroad delay and traffic congestion, and a search result transmission unit that transmits the search result of a new travel route. To transmit a request for provision of information about a new travel route and receive a search result of a new travel route, the self-driving taxi 5 includes the travel route re-search result acquisition unit 45 as shown in FIG. 5.

Thus, in the embodiment according to the present disclosure, one or a plurality of processors is included, and the one or the plurality of processors sets, as a travel destination of a vehicle, a point where an occupant of the vehicle gets out of the vehicle to transfer from the vehicle to a regularly operated transportation facility; acquires delay information indicating occurrence of a delay of the regularly operated transportation facility or occurrence of an event that causes a delay in travel of the vehicle to the travel destination; and changes the travel destination of the vehicle based on the delay information.

In the embodiment according to the present disclosure, an information processing method that performs information processing using one or a plurality of processors is provided. This method is characterized by setting, as a travel destination of a vehicle, a point where an occupant of the vehicle gets out of the vehicle to transfer from the vehicle to a regularly operated transportation facility; acquiring delay information indicating occurrence of a delay of the regularly operated transportation facility or occurrence of an event that causes a delay in travel of the vehicle to the travel destination; and changing the travel destination of the vehicle based on the delay information.

Further, in the embodiment according to the present disclosure, a program is provided that makes a computer function to set, as a travel destination of a vehicle, a point where an occupant of the vehicle gets out of the vehicle to transfer from the vehicle to a regularly operated transportation facility, and to acquire delay information indicating occurrence of a delay of the regularly operated transportation facility or occurrence of an event that causes a delay in travel of the vehicle to the travel destination. This program changes the travel destination of the vehicle based on the delay information.

In the embodiment according to the present disclosure, the delay information is first information relating to operation of the regularly operated transportation facility being delayed relative to a timetable. When the delay information is the first information, the travel destination of the vehicle is changed so as not to use a line of the regularly operated transportation facility in which the delay exists. When the delay information is the first information, the travel destination of the vehicle is changed such that a travel distance in a line of the regularly operated transportation facility in which the delay exists becomes shorter. Further, when the delay information is the first information, the travel destination of the vehicle is changed to an available place of arrival and departure in a line of the regularly operated transportation facility other than a line in which the delay exists.

In the embodiment according to the present disclosure, the delay information is second information relating to traffic congestion on a road on which the vehicle runs toward the travel destination. When the delay information is the second information, the travel destination of the vehicle is changed so as not to use a road on which the traffic congestion exists. When the delay information is the second information, the travel destination of the vehicle is changed such that a travel distance on the road on which the traffic congestion exists becomes shorter. When the delay information is the second information, the travel destination of the vehicle is changed to an available place of arrival and departure in a line of the regularly operated transportation facility other than a line to which transfer is planned.

In the embodiment according to the present disclosure, permission is asked from an occupant of the vehicle before the travel destination of the vehicle is changed. In this case, it is also possible to change the travel destination of the vehicle without asking permission from an occupant of the vehicle.

What is claimed is:

1. An information processing device comprising one or more processors configured to:
set, as a travel destination of a vehicle, a point where an occupant of the vehicle gets out of the vehicle to transfer from the vehicle to a regularly operated transportation facility;
acquire delay information indicating occurrence of a delay of the regularly operated transportation facility or occurrence of an event that causes a delay in travel of the vehicle to the travel destination; and
change the travel destination based on the delay information.

2. The information processing device according to claim 1, wherein the delay information is first information relating to operation of the regularly operated transportation facility being delayed relative to a timetable.

3. The information processing device according to claim 2, wherein, when the delay information is the first information, the one or more processors are configured to change the travel destination so as not to use a line of the regularly operated transportation facility in which the delay exists.

4. The information processing device according to claim 2, wherein, when the delay information is the first information, the one or more processors are configured to change the travel destination becomes shorter such that a travel distance in a line of the regularly operated transportation facility in which the delay exists.

5. The information processing device according to claim 2, wherein, when the delay information is the first information, the one or more processors are configured to change the travel destination to an available place for arrival and departure in a line of the regularly operated transportation facility other than a line in which the delay exists.

6. The information processing device according to claim 1, wherein the delay information is second information relating to traffic congestion on a road on which the vehicle runs toward the travel destination.

7. The information processing device according to claim 6, wherein, when the delay information is the second information, the one or more processors are configured to change the travel destination so as not to use a road on which the traffic congestion exists.

8. The information processing device according to claim 6, wherein, when the delay information is the second information, the one or more processors are configured to change the travel destination becomes shorter such that a travel distance on the road on which the traffic congestion exists.

9. The information processing device according to claim 6, wherein, when the delay information is the second information, the one or more processors are configured to change the travel destination to an available place for arrival and departure in a line of the regularly operated transportation facility other than a line to which transfer is planned.

10. The information processing device according to claim 1, wherein the one or more processors are configured to ask permission from an occupant of the vehicle before changing the travel destination.

11. An information processing method that performs information processing using one or more processors, the method comprising:
setting, as a travel destination of a vehicle, a point where an occupant of the vehicle gets out of the vehicle to transfer from the vehicle to a regularly operated transportation facility;
acquiring delay information indicating occurrence of a delay of the regularly operated transportation facility or occurrence of an event that causes a delay in travel of the vehicle to the travel destination; and
changing the travel destination based on the delay information.

12. A non-transitory storage medium storing instructions that are executable by one or more processors and that cause the one or more processors to perform functions, the functions comprising:
setting, as a travel destination of a vehicle, a point where an occupant of the vehicle gets out of the vehicle to transfer from the vehicle to a regularly operated transportation facility;
acquiring delay information indicating occurrence of a delay of the regularly operated transportation facility or occurrence of an event that causes a delay in travel of the vehicle to the travel destination; and
changing the travel destination based on the delay information.
